(19) United States
(12) Patent Application Publication
(10) Pub. No.: US 2010/0269646 A1
(43) Pub. Date: Oct. 28, 2010

(54) ANGLE-HEAD SCREWDRIVING TOOL INCORPORATING A TORQUE SENSOR MOUNTED ON THE OUTPUT SHAFT, AND CORRESPONDING TRANSMISSION MODULE

(75) Inventors: Nicolas Le Du, Quimperle (FR); Jean-Clair Leme, Reze (FR); Benoît Allenou, Orvault (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Etablissements Georges Renault, Saint Herblain (FR)

(21) Appl. No.: 12/095,667

(22) PCT Filed: Nov. 30, 2006
(86) PCT No.: PCT/EP06/69145

§ 371 Date: May 8, 2009

(30) Foreign Application Priority Data
Dec. 1, 2005 (FR) 0512212

(51) Int. Cl. B25B 23/142; B25B 21/00

(52) U.S. Cl. 81/478; 81/57

(57) ABSTRACT

A screwdriving tool is provided, which includes a drive shaft; an angle head having an output shaft whose axis of rotation is approximately orthogonal to the axis of the drive shaft; a transmission connecting the drive shaft to the output shaft; and at least one torque sensor built into the output shaft. The tool transmission includes at least one intermediate gear whose axis is appropriately parallel to the output shaft and which engages with a gear designed to turn the output shaft, and at least one bevel coupling connecting, directly or indirectly, the drive shaft to the intermediate gear or gears.

### CROSS-REFERENCE TO RELATED APPLICATIONS

This Application is a Section 371 National Stage Application of International Application No. PCT/EP2006/069145, filed Nov. 30, 2006 and published as WO 2007/063106A1 on Jun. 7, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of tools. More specifically, the disclosure relates to industrial tools, and more particularly to tools provided for exerting a screwing action with a given torque.

### BACKGROUND OF THE DISCLOSURE

In the field of the disclosure, screwing tools are very commonly used in the industrial sector, regardless of whether the tools are fixed (which includes tools mounted on machines or manipulators) or portable.

These tools may incorporate electric or pneumatic drive means depending on the envisaged applications.

According to a broader use of these tools, the latter are connected by a suitable connection to an electronic controller (in the form of a control unit) which makes it possible to program a large number of operating cycles (for example 250 cycles), it being possible for each cycle to be composed of 20 operating phases.

These cycles may be programmed directly on a keyboard provided on the electronic control unit or via associated programming software (the electronic control unit or units then being connected to the programming system via a network of the fieldbus, Ethernet or other type).

These systems make it possible to ensure a traceability of the operations carried out by the tool, for example by recording results such as the final screwing torque, the final screwing angle, the date and time of the operations or else curves representative of the quality (good or bad, depending on predetermined parameters) of the screwing carried out.

The tool itself may also comprise means for indicating the quality of screwing, for example by supplying a “Good/Bad” report that can be displayed by means of LEDs.

It will be understood that the systems of this type make it possible to carry out a wide range of parameterisation and control operations.

According to another known technique, the tool is connected to the mains power so as to supply an electronic control circuit incorporated in the tool. In this case, the tool has a small display and a few control buttons.

It will be understood that, in one or the other of the technologies described above, the data relating to the tightening torque are essential for correctly controlling the tools and for being able to monitor the screwing results.

This is because the data relating to the tightening torque are used several times, in order to ensure of course the quality of the assembly process to be carried out by screwing, but also to allow a traceability of the operations and to carry out statistical processing of the tightening data.

At present, the torque sensors used in screwing tools consist of strain gauges (generally bridge-mounted).

As illustrated in FIG. 1, these strain gauges are mounted on a support consisting of a cylindrical element 1, the torsional deformation of which is measured via the gauges, this deformation being translated into a measurement of the tightening torque.

Conventionally, this cylindrical element is associated with a reducer comprising an epicycloidal train, the structure of which is recalled below.

A reduction mechanism comprising a single-stage epicycloidal train has:
a tube with an inner ring gear referred to as the reducing ring gear;
one or more planet gears;
a planet carrier;
a sun gear.

A screwing tool as shown in FIG. 1, according to which the torque sensor is incorporated on the reducing ring gear, is the most common technique for measuring the screwing torque.

According to this technique, the movement of the reducing ring gear is then transmitted to the output shaft via a ring-and-pinion gear 2.

However, depending on the state of wear or lubrication of this gear, a loss of torque occurs at this point which results in a difference between the torque measured on the ring gear and the torque applied to the screw to be tightened.

This leads to the users of this type of tool carrying out frequent and expensive checks on these tools.

According to another known technique, illustrated in FIG. 2, the measurement of the tightening torque of a screwing tool is obtained via a torque sensor 3 incorporated on the output shaft of the angled head, at the output of the conical coupling 2.

Furthermore, according to this technique, the technology of the torque sensor is of the type which uses:
strain gauges adhesively bonded to the output shaft;
an electronic circuit installed on the output shaft;
a rotary transformer.

The rotary transformer supplies to the installed circuit a voltage which, once rectified, supplies the bridge of strain gauges, which itself produces an output signal in the form of a voltage which is converted into a frequency signal by the installed circuit so as then to be recovered via the rotary transformer.

This type of sensor is described in the patent document published under the number DE-1 980 4695.

This solution makes it possible to measure the torque actually applied to the screw since there is no disruptive element between the screw and the sensor.

Furthermore, the sensor technology used in this solution avoids the problems of wear and continuity of the signal which are conventionally encountered with rotary collectors (due to the use of brushes in rotary contact with the collector tracks, generating a friction which inevitably leads to wear of the brushes).

By contrast, the presence of this sensor at the output of the angled head has the disadvantage of significantly increasing the height of the head and, consequently, reducing the accessibility of the tool to small spaces.

In general, when designing an angled-head screwing tool, the best compromise is sought in particular between the following parameters:
reliability, in particular in terms of the torque actually applied to the screw compared to the measured torque. Losses of torque may occur as a result of wear on the conical coupling, its yield then varying as a function of wear. However, there is a degree of uncertainty with regard to the state of wear of the conical coupling of the screwing tool, this uncertainty being overcome in practice by daily checks (automatic prediction and/or compensation of the level of wear not existing at present);
precision of measurement of the tightening torque;
durability of the screwing tool.

### SUMMARY

An aspect of the disclosure relates to a screwing tool comprising:
a drive shaft;
an angled head comprising an output shaft, the axis of rotation of which is substantially orthogonal to the axis of said drive shaft;
transmission means which connect said drive shaft to said output shaft;
at least one torque sensor incorporated on said output shaft;
characterised in that said transmission means comprise at least one intermediate gear having an axis substantially parallel to said output shaft and cooperating with a gear which is designed to drive in rotation an output shaft, and at least one conical coupling which connects, directly or indirectly, said drive shaft and said intermediate gear or gears.

In this way, a screwing tool according to an embodiment of the invention makes it possible to incorporate a torque sensor on the output shaft so as to measure precisely (the sensor being placed as close to the screw as possible) the torque actually applied to the screw, while retaining a head height comparable to the standard tool described in the prior art (in which the torque sensor is mounted on the reducing ring gear).

Furthermore, such a screwing tool avoids the use of a conical coupling directly in the angled head, this type of embodiment causing disadvantages in terms of durability (in addition to its size).

An embodiment of the invention therefore proposes a design of an angled head which is more durable than the existing solutions, by driving the output shaft via parallel gears rather than by a conical coupling. Parallel gears are easier to manufacture, control and adjust. Furthermore, they offer a more homogeneous contact between the teeth and a larger contact surface area. This results in a durability greater than that of a conical coupling.

In parallel, the conical coupling placed at the output of the drive shaft admittedly rotates more quickly but is subjected to a much lower torque than when it is placed in the angled head. Consequently, it is less susceptible to wear and/or breakage.

According to one advantageous solution, said transmission means comprise a train of parallel intermediate gears, the axes of which are parallel to said output shaft.

It is thus possible to easily adapt the reduction between the drive shaft and the output shaft, via the choice of gears.

It will be recalled that a reduction has the aim of increasing the final torque with respect to the driving torque, and consequently of reducing at the output of the tool the speed of rotation with respect to that of the drive shaft. The reduction ratio is thus determined as a function of the screwing torque that it is desired to achieve and as a function of the available driving torque.

Furthermore, the presence and length of the gear train make it possible to further reduce the size of the conical coupling with respect to the angled head, so as to ensure a good accessibility of the tool to small spaces.

According to one advantageous feature, said transmission means are mounted within a module which can be detached from an element incorporating said torque sensor.

According to another advantageous feature, said transmission means are mounted within a module which can be detached from a body incorporating said drive shaft and drive means.

According to one or the other of these features, preferably according to a combination thereof, a screwing tool of modular design is obtained in which the three main constituents of the tool (motor, reduction mechanism and sensor) can be manufactured independently and brought together at the end of assembly by a few screws.

Such a design makes it possible to separate the components of different technology and allows them to be produced in separate production centres.

Furthermore, the advantages with regard to maintenance are obvious, it being possible for defective components to be replaced rapidly.

Preferably, said transmission means are associated with sealed ball bearings.

Such a module is therefore sealed and can be perfectly independent of the drive block and/or of the torque sensor/module pair.

According to one advantageous solution, said torque sensor comprises at least one strain gauge adhesively bonded to said output shaft.

Preferably, said torque sensor comprises an electronic circuit installed on said output shaft.

According to another feature, said torque sensor comprises a rotary transformer.

According to one preferred solution, said gear is guided in an upper part of said angled head by at least one ball bearing on either side of the toothing of said gear.

Advantageously, said output shaft is guided in a lower part of said angled head by at least one bearing comprising two rows of balls.

According to one particularly advantageous embodiment, said gear is guided in an upper part of said angled head by at least one ball bearing on either side of the toothing of said gear, said output shaft being guided in a lower part of said angled head by at least one bearing comprising two rows of balls.

Preferably, said bearing or bearings for guiding said gear are sealed bearings.

In this way, it is possible to avoid the risks of a possible leakage of grease from the train of gears and/or from the gear coupled to the output shaft towards the sensor (which limits the risk of measurement disruption).

Advantageously, said element comprises a casing, said tool comprising stop means which make it possible to diffuse into said casing axial stresses which are exerted on said output shaft.

An embodiment of the invention also relates to a transmission module designed to be incorporated in a screwing tool comprising:
a drive shaft;
an angled head comprising an output shaft, the axis of rotation of which is substantially orthogonal to the axis of said drive shaft;
transmission means which connect said drive shaft to said output shaft;
at least one torque sensor incorporated on said output shaft,

characterised in that it incorporates said transmission means, the latter comprising at least one intermediate gear which has an axis designed to extend parallel to said output shaft and which is designed to cooperate with a gear borne by said output shaft, and at least one conical coupling which is designed to connect, directly or indirectly, said drive shaft and said intermediate gear or gears.

### BRIEF DESCRIPTION OF THE DRAWINGS

Other features and advantages will become more clearly apparent on reading the following description of a preferred embodiment of the invention, given purely by way of non-limiting example, and the appended drawings in which:

FIG. 1 is a view in longitudinal section of an angled-head screwing tool according to a first embodiment of the prior art;

FIG. 2 is a view in longitudinal section of an angled-head screwing tool according to a second embodiment of the prior art;

FIG. 3 is a view in longitudinal section of a preferred embodiment of the invention;

FIG. 4 is a view of the invention according to the embodiment illustrated in FIG. 3, showing the assembly of the tool as modules that can be separated;

FIGS. 5 and 6 are views of a screwing tool according to an embodiment of the invention, respectively from above and in longitudinal section;

FIG. 7 is another view of a screwing tool according to an embodiment of the invention, showing the transmission and sensor modules in the separated state;

FIG. 8 is a view of the sensor module from above.

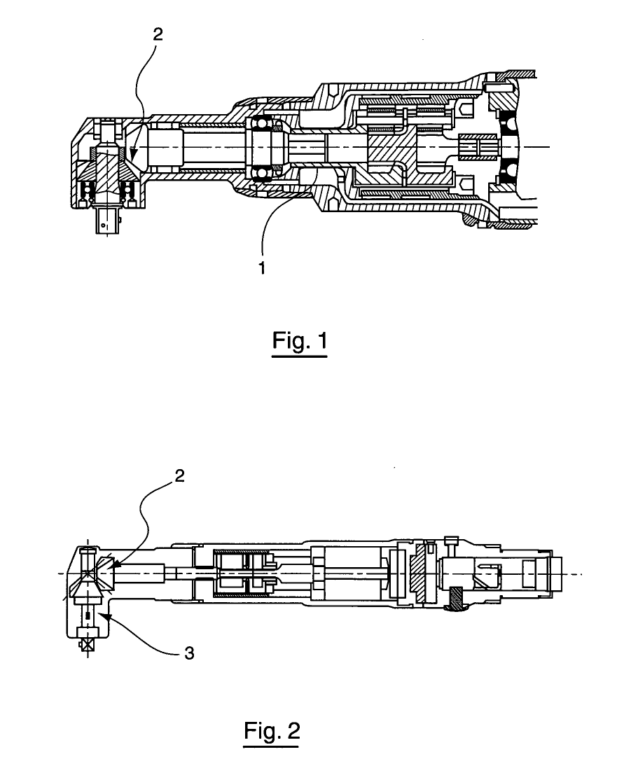

### DETAILED DESCRIPTION OF ILLUSTRATIVE EMBODIMENTS

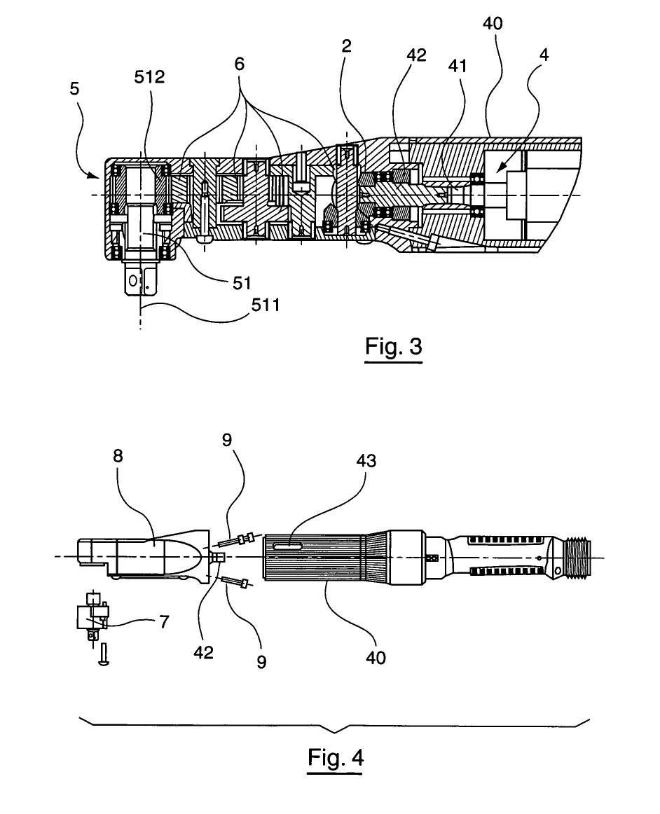

With reference to FIG. 3, an embodiment of the invention applies to a screwing tool comprising a drive shaft 4 and an angled head 5, the output shaft 51 of which has an axis of rotation 511 substantially orthogonal to the axis of the drive shaft 4.

The drive shaft 4 and the output shaft 5 are connected in rotation by transmission means.

According to the principle of an embodiment of the invention, these transmission means comprise a conical coupling 2 connecting the drive shaft 4 directly or indirectly to an intermediate gear, the axis of rotation of which is parallel to the axis of rotation of the output shaft, this intermediate gear cooperating with the output shaft via another gear borne by the output shaft.

It will be understood that in this way the conical coupling is brought closer to the drive block incorporating the shaft. This conical coupling is, in other words, provided close to the end of the drive shaft (or is borne by this end) so that the size thereof does not impair the accessibility of the angled head to small spaces.

In yet other words, the conical coupling is remote from the angled head, one or more gears having an axis parallel to the output shaft being inserted between the output shaft and the conical coupling.

According to the embodiment of the invention which is shown in FIG. 3, the conical coupling 2 is mounted at one end of the drive shaft 4 (consisting here of a main body 41 and an extension 42), and a train of parallel gears 6 is mounted between the conical coupling 2 and a gear 512 which is designed to drive in rotation the output shaft 51.

It will be understood that the screwing tool thus formed comprises a reducing chain which couples the motor to the output shaft and that this reducing chain has as an input member the conical coupling. Since the torque being exerted on the elements of the chain increases in the direction towards the output shaft, the positioning of the conical coupling directly at the output of the drive shaft makes it possible to reduce to a maximum the torque to which the conical coupling is subjected.

The tool uses a torque sensor technology described above with reference to the prior art (that is to say of the type described in the document published under the number DE-1 980 4695). It will be recalled that such a sensor comprises: strain gauges adhesively bonded to the output shaft;
an electronic circuit installed on the output shaft;
a rotary transformer.

The rotary transformer supplies to the installed circuit a voltage which, once rectified, supplies the bridge of strain gauges, which itself produces an output signal in the form of a voltage which is converted into a frequency signal by the installed circuit so as then to be recovered via the rotary transformer.

A torque sensor of a different technology could however be used according to another embodiment that can be envisaged.

With reference to FIG. 4, the torque sensor is designed in the form of an independent module 7 which is fixed by two screws to a transmission module 8 of the tool.

The shaft of this sensor comprises male splines for transmitting the torque, these splines being designed to fit into the parallel toothed gear 512 (FIG. 3) so as to allow transmission of the torque.

This gear 512 is itself driven by a train of parallel toothed gears, as mentioned above.

This arrangement makes it possible to retain a head height comparable to that of the standard tool, and proves to be much more compact than the tool shown in FIG. 2.

The reduction mechanism therefore comprises gears 6 forming a reduction having a ratio adapted to the level of torque that it is desired to achieve at the output of the tool.

The gears 6 and the conical coupling 2 are incorporated in the module 8, which can itself be separated from the drive block 40 as will be explained in greater detail below.

It will be noted that the extension 42 of the drive shaft is incorporated in the module 8, the latter having one end which is designed to be housed in the end of the main body 4 of the drive shaft so as to cause the main body and the extension to be secured in rotation. This module 8 is equipped with sealed ball bearings which make it possible to contain the grease necessary for lubricating the gears. This module 8 is also sealed and independent.

The fixing of the module to the drive block 40 is carried out via three screws 9 spaced apart by 120° and inclined by 15° relative to the drive axis (it also being possible of course to envisage a greater number of screws). This arrangement makes it possible to reduce the external size of this fixing, and allows easy assembly and detachment without the need for a special key or high tightening torque or adhesive bonding requiring the use of heating of the tool by means of a hot air gun at the time of disassembly.

FIGS. 5 to 8 show a variant embodiment of a screwing tool according to the invention.

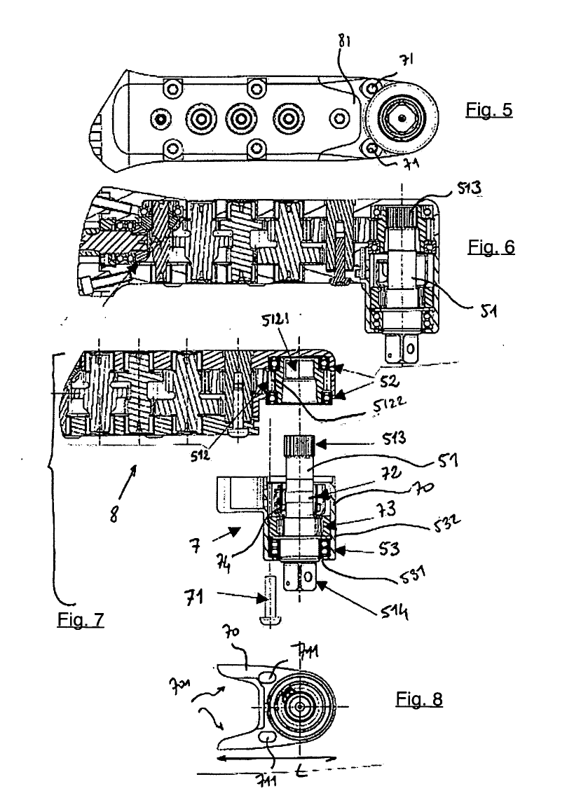

As can be seen in FIGS. 6 and 7, the output gear 512 is supported on either side of its toothing (5122) by two ball bearings 52 which together absorb the transmission stresses being exerted on the gear 512, these stresses being generated by the train of intermediate gears 6. Consequently, the gear 512 does not transmit any flexion force to the output shaft (any flexion forces on the output shaft being of such a nature as to not disrupt the measurement of the torque) via the female splines 5121 (of the gear 512) and the male splines 513.

It will be noted that the presence of two ball bearings 52 (instead of just one) prevents an off-centre mounting of the gear 512, thus avoiding a “swivel” effect which would be present in the case of a single bearing.

In other words, this mounting of a bearing on either side of the gear 512 improves the rigidity of guidance (by being at a distance from one another) and ensures a homogeneous distribution of the stresses on the bearings, while being contained within a reduced size.

Such an assembly therefore limits the forces transmitted to the output shaft via the gear 512 to just the screwing torque.

The output shaft is supported in its lower part by a ball bearing which may alternatively be a rigid ball bearing (case of FIG. 3) or a bearing comprising a double row of balls 53 (FIG. 7). Preferably, this bearing is a bearing comprising a double row of balls which makes it possible to absorb all of the flexion forces generated by the output bushing on the square drive 514 and thus eliminates the external disruptions on the sensor, which would not be the case with a bearing with an oblique contact.

According to another feature, stop means 531, 532 are provided which make it possible to diffuse into the casing 70 of the sensor module the axial stresses exerted from the outside on the square drive. It is thus possible to avoid transmitting these forces to the active part of the sensor.

These means comprise, according to the present embodiment, a stop annulus 531 which is mounted in a groove formed on the shaft 51, this annulus bearing against the inner ring of the bearing 53. In parallel, a second stop annulus 532 is mounted in a groove formed in the interior of the casing 70, this annulus bearing against the outer ring of the bearing 53.

Furthermore, it will be noted that the ball bearings 52 are sealed. No leakage of grease is possible from the train of gears 6 and/or from the gear 512 towards the sensor (which limits the risk of measurement disruption).

In the same way, it is provided that the bearing 53 is sealed, thus avoiding any uptake of external fluid towards the sensor.

The technology for supplying power to the gauge bridge 72 and to the installed electronic circuit 74 and for recovering the signal is based on the use of a rotary transformer 73. No wear of brushes is therefore possible.

As mentioned above, the sensor module 7 is designed as an independent module which is fixed by two screws 71 to the rest of the tool. This results in obvious advantages with regard to manufacture and maintenance, the sensor module and its internal elements thus being easily accessible and/or replaceable.

More specifically, the module 7 comprises a casing 70 having two wings 701 which delimit between them a concave shape designed to accommodate the correspondingly shaped end 81 of the transmission module. These wings 701 provide a seat on the transmission module and help to ensure the stability of the fixing of the sensor module on the transmission module in the event of lateral or longitudinal impact.

It will also be noted that the holes 711 for receiving the fixing screws 71 are substantially centred with respect to the length L of the casing 70 of the module, thus contributing, together with the general shape of the casing, to the stability of the fixing of the sensor module on the transmission module.

Furthermore, the power supply to the sensor module and the recovery of the frequency signal is carried out by just two wires which do not require any particular electromagnetic protection given the technology of the sensor used. These two wires pass through a conduit formed in the thickness of the casing of the transmission module for reasons of mechanical protection. The wires are connected to a power supply and to a module for processing the frequency signal, both present in the handle of the tool.

An embodiment of the invention proposes an angled screwing tool, which is more reliable than the existing solutions, in particular in that it makes it possible to measure the torque actually applied to a screw.

An embodiment of the invention provides such a screwing tool, which offers a satisfactory and durable level of precision in terms of torque measurement.

An embodiment of the invention provides such a screwing tool, which avoids any significant increase in height of the angled head.

An embodiment of the invention provides such a screwing tool, which can be manufactured more easily than conventional screwing tools, in particular in that it can be manufactured with minimum logistical constraints, by using remote skills and/or production centers.

An embodiment of the invention provides such a screwing tool, which makes it possible to envisage appreciable gains in terms of maintenance.

An embodiment of the invention provides such a screwing tool, which is of simple design and is easy to use.

Although the present disclosure has been described with reference to one or more examples, workers skilled in the art will recognize that changes may be made in form and detail without departing from the scope of the disclosure and/or the appended claims.

1. Screwing tool comprising:
a drive shaft;
an angled head comprising an output shaft, the axis of rotation of which is substantially orthogonal to the axis of said drive shaft;
a transmission which connects said drive shaft to said output shaft;
at least one torque sensor incorporated on said output shaft,
wherein said transmission comprises at least one intermediate gear having an axis substantially parallel to said output shaft and cooperating with a gear which is designed to drive in rotation said output shaft, and at least one conical coupling which connects, directly or indirectly, said drive shaft and said intermediate gear or gears.

2. Screwing tool according to claim 1, wherein said transmission comprises a train of parallel intermediate gears, the axes of which are parallel to said output shaft.

3. Screwing tool according to claim 1 wherein said transmission is mounted within a module which can be detached from an element incorporating said torque sensor.

4. Screwing tool according to claim 1, wherein said transmission is mounted within a module which can be detached from a body incorporating said drive shaft and drive means.

5. Screwing tool according to claim 1, wherein said transmission is associated with sealed ball bearings.

6. Screwing tool according to claim 1, wherein said torque sensor comprises at least one strain gauge adhesively bonded to said output shaft.

7. Screwing tool according to claim 1, wherein said torque sensor comprises an electronic circuit installed on said output shaft.

8. Screwing tool according to claim 1, wherein said torque sensor comprises a rotary transformer.

9. Screwing tool according to claim 1, wherein said gear is guided in an upper part of said angled head by at least one ball bearing on either side of toothing of said gear.

10. Screwing tool according to claim 1, wherein said output shaft is guided in a lower part of said angled head by at least one bearing comprising two rows of balls.

11. Screwing tool according to claim 1, wherein said gear is guided in an upper part of said angled head by at least one ball bearing on either side of toothing of said gear, said output shaft being guided in a lower part of said angled head by at least one bearing comprising two rows of balls.

12. Screwing tool according to claim 11, wherein said bearing or bearings for guiding said gear are sealed bearings.

13. Screwing tool according to claim 3, wherein said element comprises a casing, said tool comprising stop means, which make it possible to diffuse into said casing axial stresses which are exerted on said output shaft.

14. Transmission module designed to be incorporated in a screwing tool comprising:
a drive shaft;
an angled head comprising an output shaft, the axis of rotation of which is substantially orthogonal to the axis of said drive shaft;
a transmission which connects said drive shaft to said output shaft;
at least one torque sensor incorporated on said output shaft;
wherein the module incorporates said transmission, the latter comprising at least one intermediate gear which has an axis designed to extend parallel to said output shaft and which is designed to cooperate with a gear borne by said output shaft, and at least one conical coupling which is designed to connect, directly or indirectly, said drive shaft and said intermediate gear or gears.
